(19) United States
(12) Patent Application Publication
(10) Pub. No.: US 2003/0229533 A1
(43) Pub. Date: Dec. 11, 2003

(54) System and method for creating compiled marketing research data over a computer network

(76) Inventors: Mary E. Mack, Dallas, TX (US); Justin B. Hill, Flower Mound, TX (US)

Correspondence Address: Lawrence R. Youst, Danamraj & Youst, P.C., Suite 1200, LB-15, 12900 Preston Road, Dallas, TX, 75230-1328, US

(21) Appl. No.: 10/165,647

(22) Filed: Jun. 6, 2002

(51) Int. Cl. G06F 17/60

(52) U.S. Cl. 705/10

(57) ABSTRACT

A system for creating compiled marketing research data over a computer network is disclosed. The system comprises a researcher server system (12), multiple respondent systems (18, 20) in communication with the researcher server system (12) and at least one client system (14) in communication with the researcher server system (12). The researcher server system (12) is operable to provide multiple questions, to receive corresponding responses and to compile the received responses in substantially real-time. Each respondent system (18, 20) is operable to receive the questions from the researcher server system (12) and provide the survey responses to the researcher server system (12). The client system (14) is operable to access the compiled responses in substantially real-time, thereby creating compiled marketing research data over the computer network.

### TECHNICAL FIELD OF THE INVENTION

The invention relates in general to a system and method for conducting marketing research and, in particular, to a system, method and computer program for creating compiled marketing research data over a computer network in substantially real-time.

### BACKGROUND OF THE INVENTION

In today's marketplace, businesses must identify and define marketing opportunities and problems, generate, refine, and evaluate marketing actions, monitor marketing performance, and improve understanding of marketing as a process. Marketing research specifies the information required to address these marketplace issues, designs the methods for collecting the information, manages and implements the data collection process and analyzes and communicates the findings and their implications.

In marketing research, surveys provide an invaluable tool that allows researchers to quickly and effectively gather the required information to resolve marketplace issues. Traditionally, mall-intercept surveys and telephonic surveys were used to gather information. In a traditional mall-intercept survey, face-to-face interviews are conducted between a researcher and a respondent belonging to a particular group or having a particular profile. The researcher asks the respondent a series of related questions about a product or service idea. Face-to-face interviewing allows a researcher to employ stimuli such as product samples and pictures during the interview. The data collected by the researcher is then tabulated and analyzed to yield insights and solutions to the marketplace issues. It has been found, however, that face-to-face interviews are expensive and may take a long period of time to arrange and conduct. For example, to obtain a geographically diverse sample, the researcher may incur significant travel expenses or multiple researchers may have to be hired in the desired geographical regions. Additionally, it has been found that some respondents will give researchers biased responses when face-to-face with the researcher.

In a traditional telephonic survey, a researcher asks a respondent a set of related questions about a product or service idea via telephone. Telephonic interviews yield random, geographically diverse samples and are much less expensive than face-to-face interviews. While telephonic surveys eliminate a portion of the logistical problems and expense associated with mall-intercept surveys, it has been found that telephonic interviews often prove intrusive and interrupt respondents at inopportune times such as dinner. Often, a respondent will simply not answer or hang up if approached via telephone by a researcher. Additionally, stimulus such as visual aids can not be employed during a telephonic interview.

The limitations of face-to-face interviews and telephonic interviews have caused researchers to develop new ways to collect marketing research. With the advent of large scale computer networks, such as the Internet, it is now much easier to link respondents electronically and thus avoid the logistical problems and expenses associated with mall-intercept surveys. Moreover, Internet surveys allow a researcher to display audio and visual stimuli and reach a respondent at an opportune time.

While Internet surveys have eliminated some of the limitations of traditional mall-intercept surveys and telephonic surveys, Internet surveys are not without limitations of their own. Internet surveys require respondents to have sophisticated software knowledge to participate in the survey. Additionally, respondents are often required to install special software on their home computers to participate in the survey. Moreover, existing applications software employed to conduct surveys still relies on traditional data processing techniques to compile the data obtained during the Internet survey.

Therefore, a need exists for a network based system and method for conducting a survey that does not require respondents to have a sophisticated knowledge of software. Furthermore, a need exists for such a system and method to operate without special software on the respondents' computers. Additionally, a need exists for such a system and method to be implementable without significant programming knowledge on the part of the researcher. Moreover, a need has also arisen for such a system and method to employ faster and more robust data collection and processing techniques.

### SUMMARY OF THE INVENTION

The present invention disclosed herein comprises a computer network based system, method and computer program for creating compiled marketing research data. The system, method and computer program of the present invention provide a network based solution for conducting a survey that does not require respondents or researchers to have a sophisticated knowledge of software. Furthermore, the system, method and computer program of the present invention operate without special software on the researcher's or respondents' computers. Moreover, the system, method and computer program of the present invention employ advanced data processing that allows clients to access compiled survey responses in substantially real-time.

The present invention comprises a researcher server system, multiple respondent systems in communication with the server system and at least one client system in communication with the researcher server system. The researcher server system is operable to provide multiple questions, to receive corresponding responses and to compile the received responses in substantially real-time. Each respondent system is operable to receive the questions from the researcher server system and provide the corresponding responses to the researcher server system. The client system is operable to create the survey and access the compiled responses in substantially real-time. Accordingly, the system of the present invention provides compiled marketing research data over the computer network.

The researcher server system is operable to export the responses to the client system(s) in a variety of predetermined formats including a raw data format. Additionally, the compiled responses may include survey responses subjected to data analysis. The data analysis may include aggregation or a multivariate analysis such as regression analysis, discriminant analysis, factorial multivariate analysis of variance, factor analysis, hierarchical cluster analysis, partition cluster analysis and the like. The type of data analysis employed may be chosen by the researcher server system or the client system.

In another aspect, the present invention is directed to a method for presenting instructions and answers to a respondent. The method comprises the steps of generating multiple unpresented questions, each unpresented question comprising an instruction and an answer, sequentially presenting the multiple unpresented questions to the respondent, thereby each unpresented question becomes a presented question, sequentially receiving responses from the respondent to the presented questions, modifying an answer to one of the unpresented questions of the multiple questions based on one or more of the sequentially received responses, and presenting the modified unpresented question to the respondent.

In one embodiment, the advanced logic system, such as an expert system, neural network or fuzzy logic, may be used to modify the answer choices to one of the unpresented questions based on one or more of the sequentially received responses. The method may further comprise modifying the sequence in which the unpresented questions are presented to the respondent based on the sequentially received responses from the respondent or deleting an unpresented question based on the sequentially received responses from the respondent.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a platform diagram illustrating a system for creating compiled marketing research data over a computer network of the present invention;

FIG. 2 is a flow diagram illustrating a method for creating compiled marketing research data over a computer network of the present invention;

FIG. 3 is a screen diagram illustrating the client interface through which a client may create or modify a respondent message;

FIG. 4 is a screen diagram illustrating a client interface through which a client may design a question;

FIG. 5 is a screen diagram illustrating a client interface through which a client may design a respondent message;

FIG. 6 is a screen diagram illustrating the client interface through which a client may edit a question;

FIG. 7 is a screen diagram illustrating a respondent email interface through which a potential respondent is notified of a survey;

FIG. 8 is a screen diagram illustrating a respondent interface through which a respondent may log-on to a survey;

FIG. 9 is a screen diagram illustrating the respondent interface through which a respondent is completing a radio question;

FIG. 10 is a screen diagram illustrating the respondent interface through which a respondent is presented a respondent message from a researcher;

FIG. 11 is a screen diagram illustrating the respondent interface through which a respondent is completing a checkbox question;

FIG. 12 is a screen diagram illustrating the respondent interface through which a respondent is completing a grid single answer question;

FIG. 13 is a screen diagram illustrating the respondent interface through which a respondent is completing an alternate grid single answer question;

FIG. 14 is a screen diagram illustrating the client interface that displays the progress of the survey at a first time;

FIG. 15 is a screen diagram illustrating the client interface through which the client may create cross tabulations;

FIG. 16 is a screen diagram illustrating the client interface through which the client may select the type of data analysis to be performed;

FIG. 17 is a screen diagram illustrating the client interface through which the client may edit the banner points;

FIG. 18 is a screen diagram illustrating the client interface that displays the analyzed data at the first time;

FIG. 19 is a screen diagram illustrating the client interface that displays the progress of the survey at a second time;

FIG. 20 is a screen diagram illustrating the client interface that displays the analyzed data at the second time;

FIG. 21 is a screen diagram illustrating the client interface through which the client may select the output format of the data;

FIG. 22 is a screen diagram illustrating the client interface through which the client may view and download the compiled data in a raw data format;

FIG. 23 is a screen diagram illustrating the client interface through which the client may view and download a coded questionnaire; and

FIG. 24 is a screen diagram illustrating the client interface that displays the progress of the survey wherein the survey is complete.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

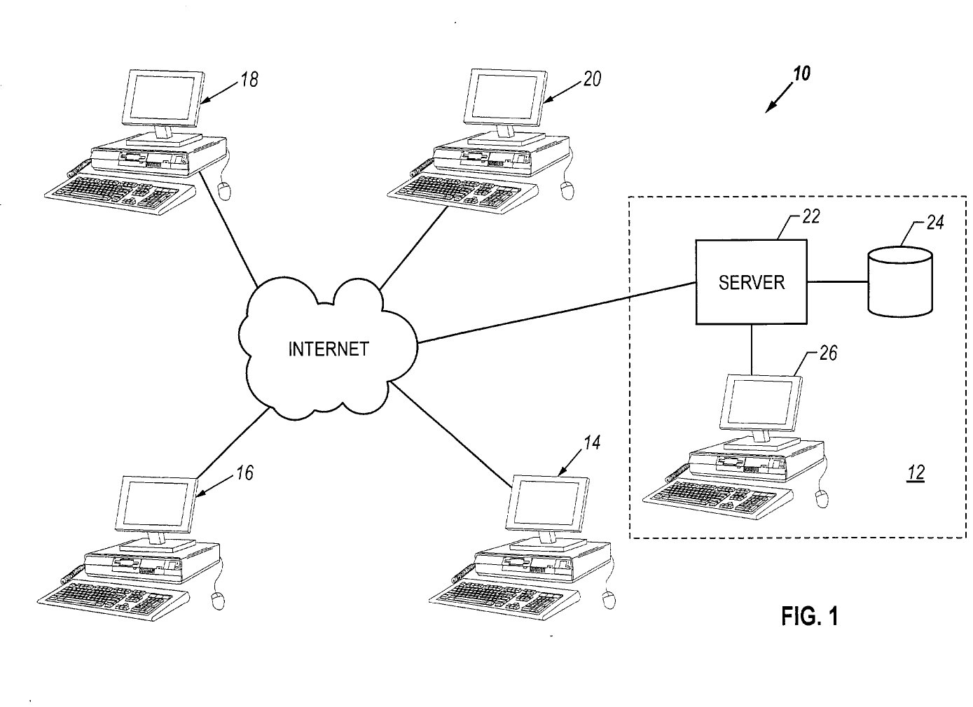

Referring initially to FIG. 1, therein is depicted a platform layout of a system for creating compiled marketing research data over a computer network of the present invention that is generally designated 10. System 10 includes a researcher server system 12, multiple client systems 14, 16 and multiple respondent systems 18, 20. Researcher server system 12 offers software application capabilities to client systems 14, 16 and respondent systems 18, 20 from a centralized data center via a Wide Area Network (WAN) such as the Internet. Alternatively, researcher server system 12, client systems 14, 16 and respondent systems 18, 20 may be connected by a direct connection such as a T1 line, a dial-up modem or the like. Importantly, only researcher server system 12 and client systems 14, 16, and researcher server system 12 and respondent systems 18, 20 must be in communication to conduct the survey.

Researcher server system 12 includes a server 22, a database 24 and a computer 26 that provide a researcher (not shown) an interface for creating compiled marketing research data in substantially real-time over a computer network as discussed in further detail below. It should be understood by those skilled in the art that any number of peripheral input, storage and display devices such as a keyboard, a mouse and a monitor may be included in server 22 and computer 26.

In the illustrated embodiment, each client system 14, 16 includes a computer connected to the Internet that allows a client (not shown) access to compiled marketing research data over a computer network in substantially real-time as explained in further detail below. Any number of peripheral input, storage and display devices such as a keyboard, a mouse and a monitor may be included in client systems 14, 16. It should be understood by those skilled in the art that although two client systems are illustrated, more or less client systems are within the teachings of the present invention.

Similarly, each respondent system 18, 20 includes a computer, comprising any number of peripheral devices, that is connected to the Internet. Respondent systems 18, 20 allow a respondent (not shown) to participate in a survey. Those skilled in the art should understand that although two respondent systems are illustrated, the number of respondent systems participating in the survey may be much greater and depends on the specifics of the survey.

The applications software of researcher server system 12 is portable and allows a survey to be prepared, conducted and compiled across the broadest range of system architectures. In a presently preferred exemplary embodiment, to employ the application software of researcher server system 12, client systems 14, 16 and respondent systems 18, 20 are not required to load additional software applications. A software web browser such as Netscape Navigator or Microsoft Internet Explorer is sufficient to access the applications software of researcher server system 12.

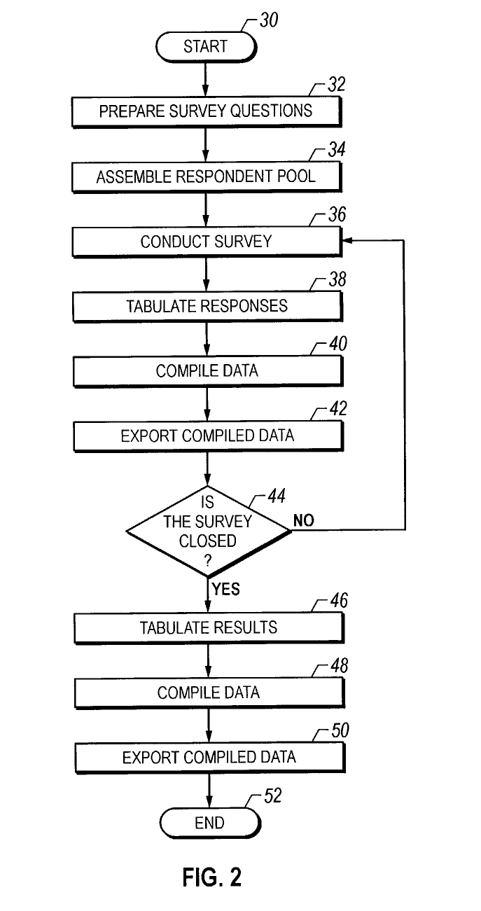

Referring now to FIG. 2, therein is depicted a flow diagram illustrating a method for creating compiled marketing research data over a computer network of the present invention. At step 30, the method begins by the client and researcher defining the problem the survey is to resolve, the sampling method, the necessary qualifications or profile of respondents, the time frame of the survey, the budget of the survey and other parameters of the data collection process. At step 32, the survey questions are designed by the researcher, the client or both. Each question includes an instruction and an answer that may include a selection of potential responses or a text box. The question may be any one of a variety of question types known in the art. For example, a question may be a radio, checkbox, short text, long text, scaled response, multiple choice, grid with single answer, grid with multi-answer or the like. A stimulus, such as an audio file, a graphical image or a video file, may accompany the presentation of a question. The actual design of the questions will be discussed in more detail below.

At step 34, the respondent pool is assembled based on the earlier composed profile of a respondent. The respondent pool may be assembled, for example, by accessing a client database of potential candidates, accessing a researcher database of potential candidates, a combination thereof or other suitably identified respondent pool. Additionally, potential respondents may be recruited by more traditional methods such as post card or phone recruitment. For example, the client may wish to conduct an online-survey of their own employee's opinions. Therefore, a necessary qualification of a respondent is being an employee of the client. In this case, a client database of employees would be used to assemble the respondent pool.

Alternatively, the survey may be concerned with the shopping and purchasing habits of a particular group of consumers. In this case, a researcher database of potential respondents may be employed. This database may be maintained in variety of ways. For example, potential respondents may access a website provided by the researcher and complete a demographic questionnaire. Thereafter, these respondents may be awarded monetary compensation for each survey he or she completes. The information gathered by the researcher from the demographic questions is stored in a database. When the researcher requires a respondent pool comprising respondents having a certain profile, such as consumers between the ages of 18 and 65, the researcher searches the information stored in the database and pre-qualifies those respondents who meet the survey profile. When a suitable number of potential respondents may be identified, the potential respondents are invited to respond to the survey. This is accomplished by emailing the potential respondents an invitation to participate in the survey. The email includes a user name and password that allows the potential respondent to participate in the survey at a specified website. After signing onto the website, each respondent may, if desired, be validated to verify the respondent's pre-qualifications. If a potential respondent is not qualified to participate in the survey or the survey is full, the respondent will be denied entry to the survey.

As the potential respondents are assembled, the survey is conducted at step 36. The survey may be an open ended survey having no predetermined period of reply, such as a presidential opinion poll, or a closed survey having a predetermined period for response, such as the shopping survey described below. The survey consists of a series of questions each comprising an instruction and an answer. Optionally, any question may be accompanied by a stimulus such as an audio file, graphical image or video file.

As the respondents participate in the survey, the responses are tabulated into data in substantially real-time at step 38. At step 40, the data is compiled. The compiled data may be formatted in a predetermined format. For example, the data may be raw data, a Microsoft Excel file or other suitable file. The formatting may include a flat file with leading zeros or right justification. Moreover, the formatted data or responses may be subjected to data analysis. The data analysis may include aggregation or more complex statistical analysis such as inferential univariate, bivariate or multivariate analysis. The multivariate analysis may include regression analysis, discriminant analysis, frequency analysis, statistical relevancy, TURF analysis, factorial multivariate analysis of variance, factor analysis, hierarchical cluster analysis, partition cluster analysis or the like. The researcher server system provides for either the client via the client system or the researcher to select the data format and data analysis to be performed as explained in more detail below. At step 42, the compiled data may be exported from the researcher server system to the client system. The exporting may include viewing the compiled data or downloading the compiled data.

At step 44, if the survey is closed, the method continues to step 46. The survey may be closed if the predetermined time period for the survey has elapsed or the desired number of respondents have completed the survey. If the survey is not closed, the method progresses such that steps 36, 38, 40 and 42 may be continuously repeated until the survey is closed. With this method, the responses from the respondents are continuously tabulated in substantially real-time and the client system has continuous access to the compiled data in substantially real-time. Additionally, the client may download the compiled marketing research data in substantially real-time. This feature is useful in creating the client or researcher to perform substantially real-time analysis on substantially real-time data. Thus the cycle of data collection, analysis and decision making is shortened.

At step 46, the survey is closed and the final results are tabulated, the data is compiled in step 48 and the data is exportable by the client in step 50 in the previously described manner. Additionally, optionally, an email may be sent to the client to let the client know the survey has closed. At step 52, the survey is complete and the researcher and client may analyze the compiled data to make decisions about market place issues.

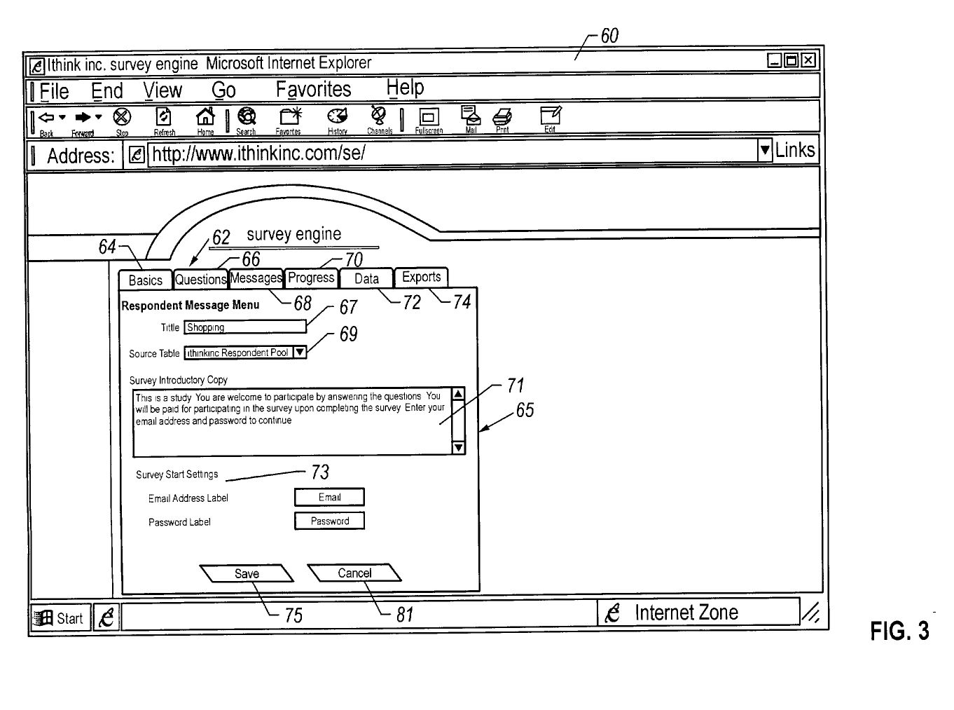

Referring now to FIG. 3, a client interface 60 is shown. In the preferred embodiment, interface 60 is implemented by using the Internet and accessed using any one of a number of commercially-available web browsers, such as Microsoft Internet Explorer and Netscape Navigator. The client interface appears as a standard website and requires no special hardware or software other than a computer and browser suitable for accessing the researcher server system.

When a client successfully logs into the designated website, a menu is provided that allows the client to navigate the website by clicking on one of six tabs 62 presented. By clicking on a basics tab 64, the client is presented with a menu that allows the client to create a new survey. By clicking on a questions tab 66, the client may edit, create or delete questions. A messages tab 68 allows the client to edit and create respondent messages. A progress tab 70 allows the client to view the progress of the survey in substantially real-time. A data tab 72 allows the client to compile the tabulated responses in substantially real-time. An exports tab 74 allows the client to export compiled data in substantially real-time.

As illustrated, the client starts at basics tab 64. Menu 65 is presented that allows the client to create a new survey introduction. Title box 67 provides a place for client to title the survey. Source table 69 provides a list of possible respondent pools such as a client respondent pool, a researcher respondent pool or the like. The client may prepare an introductory message for the respondents at text box 71. Survey start settings 73 allow the researcher to specify which pieces of identification, such as email address and/or password, are required for a respondent to login to the survey. A save icon 75 allows the client to save the newly created survey and a cancel icon 81 allows the client to delete the newly created survey.

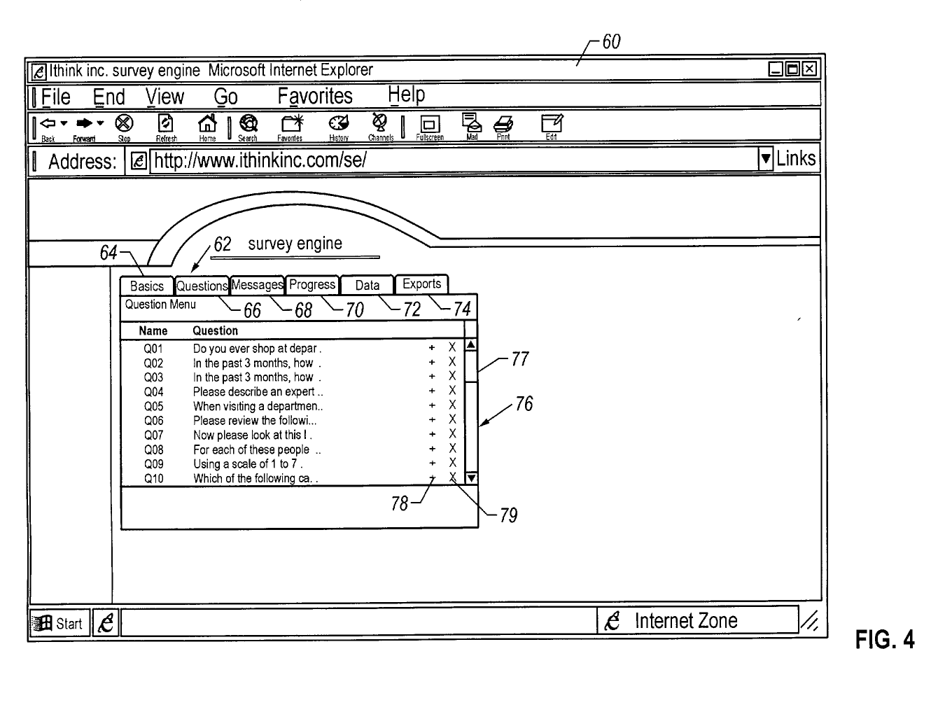

Referring now to FIG. 4, client interface 60 is depicted wherein the client has clicked on questions tab 66 after setting up the survey at basics tab 64. A question menu 76 includes 10 questions labeled Q01-Q10 as well as various navigational and editing tools. A scroll bar 77 allows the client to navigate through the questions. Add question icons 78, represented by plus signs, allow the client to add a question. Delete questions icons 79, represented by X symbols, allow a client to delete a question. By double-clicking on a question a new screen appears that allows the client to edit the question. Additionally, by dragging and dropping a question, the question may be moved to a new position in the survey. Thus, a client or researcher is not required to have sophisticated knowledge of software or sophisticated software installed on his computer to construct or develop a survey.

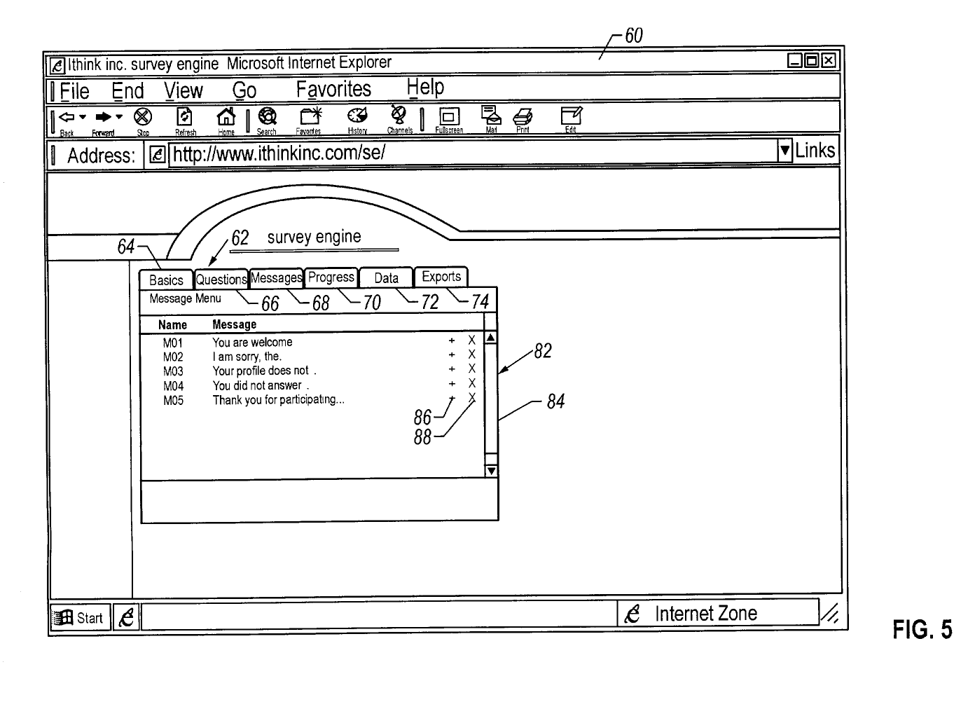

Referring now to FIG. 5, by clicking on messages tab 68, message menu 82 is loaded and built wherein the client has the opportunity to edit and create respondent messages. Message menu 82 includes 5 respondent messages labeled M01-M05 as well as various navigational and editing tools. As discussed in more detail below, messages are inserted into the survey by typing the message number, for example, M01, in a message link box of an edit question menu. A scroll bar 84 allows the client to navigate through the respondent messages. Add instruction icons 86, represented by plus signs, allow the client to add a respondent message. Delete instructions icons 88, represented by X symbols, allow a client to delete a message. By double clicking on a message, the client may edit the content or text of the message.

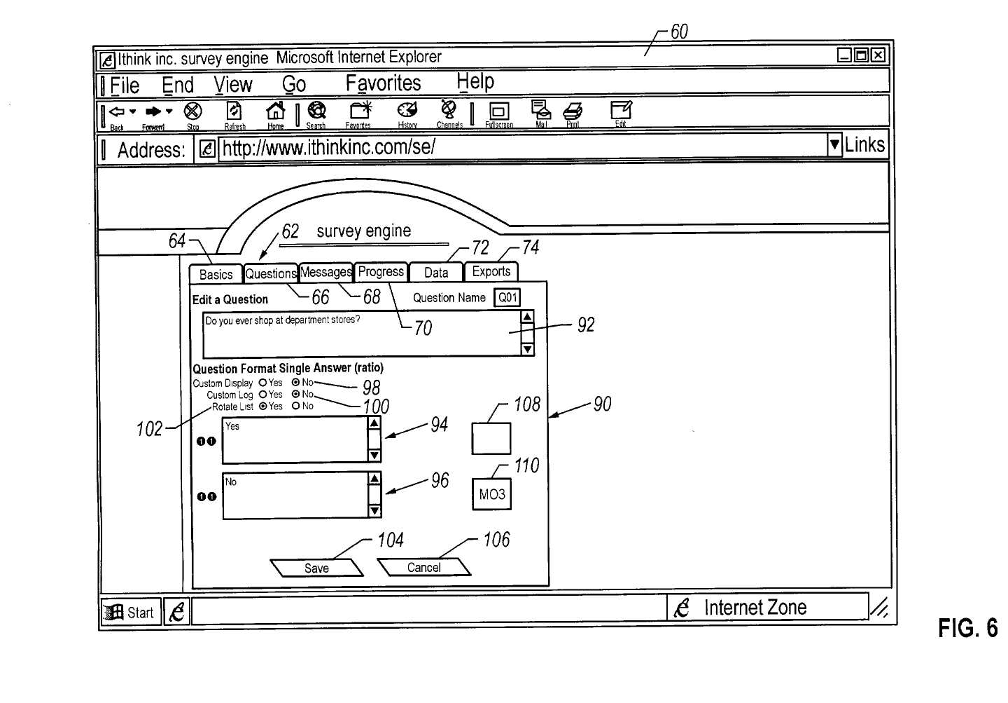

Referring now to FIG. 6, client interface 60 is shown where an edit a question menu 90 is presented that allows the client to edit the question labeled Q01 in FIG. 4. By double-clicking on Q01 in FIG. 4, menu 90 in FIG. 6 is loaded and built. Menu 90 includes several tools that allow the client to edit the text of the question such as an instruction text box 92 and answer text boxes 94, 96. A custom display option 98 allows the researcher server system to use advanced logic and edit the answers presented to the respondent based on the respondent's responses. Similarly, a custom log option 100 allows the researcher server system to use advanced logic to modify the order the questions are presented to the respondent based on the respondent's responses. The functionality of these two features, custom display and custom log, will be discussed in further detail below. A rotate list option 102 allows the client or researcher to randomly present the answer order to an instruction to prevent order bias from occurring. Save icon 104 and cancel icon 106 allow the client to save or cancel the question edit, respectively. After saving or cancelling the edit, client interface 60 returns to the questions menu 76 of FIG. 4. As illustrated, the question is a radio question. As previously discussed, however, the question may of a variety of types. Message link boxes 108 and 110 allow the client to link to particular responses to messages. For example, client has entered M03 into message link box 110. During the survey, if a respondent selects “No” as his response to the instruction, then respondent message M03 is displayed. As discussed, respondent message M03 was created at the message menu of messages tab 68.

It should be understood by those skilled in the art that based on the user name and password, the various client permissions may be modified. Moreover, different clients may have different permissions. For example, one client may only be permitted to view questions while another client may be permitted to edit and create questions and respondent messages. Furthermore, it should be understood by those skilled in the art that the researcher is able to edit and create questions and respondent messages via a similar interface.

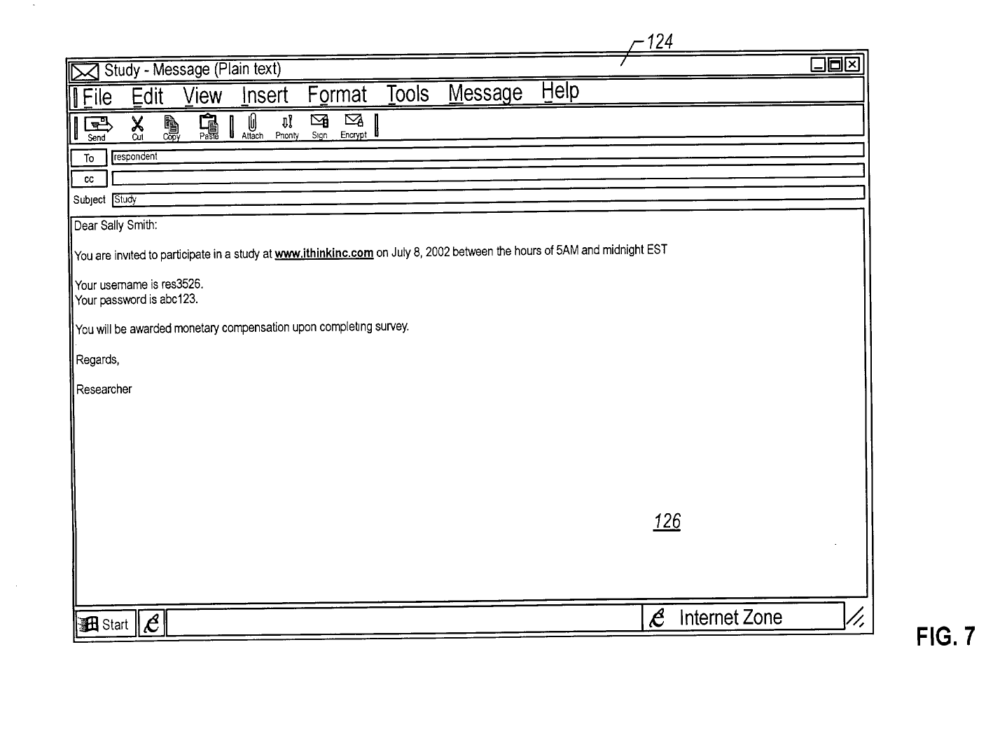

Referring now to FIG. 7, in order to conduct a survey in a networked environment such as the Internet, multiple respondents must be gathered. FIG. 7 illustrates a respondent email interface 124 inviting a potential respondent to participate in a survey. In the preferred embodiment, the email interface may be any one of multiple commercially available email programs such as Microsoft Outlook® or Qualcomm Eudora®. A body of the email 126 includes the website address of the survey as well as a user name and password for the potential respondent. The user name and password not only serve to verify the identity of the potential respondent, but also serve to protect the anonymity of the potential respondent. Thus, the email provides a non intrusive communication to a potential respondent alerting the potential respondent to the survey.

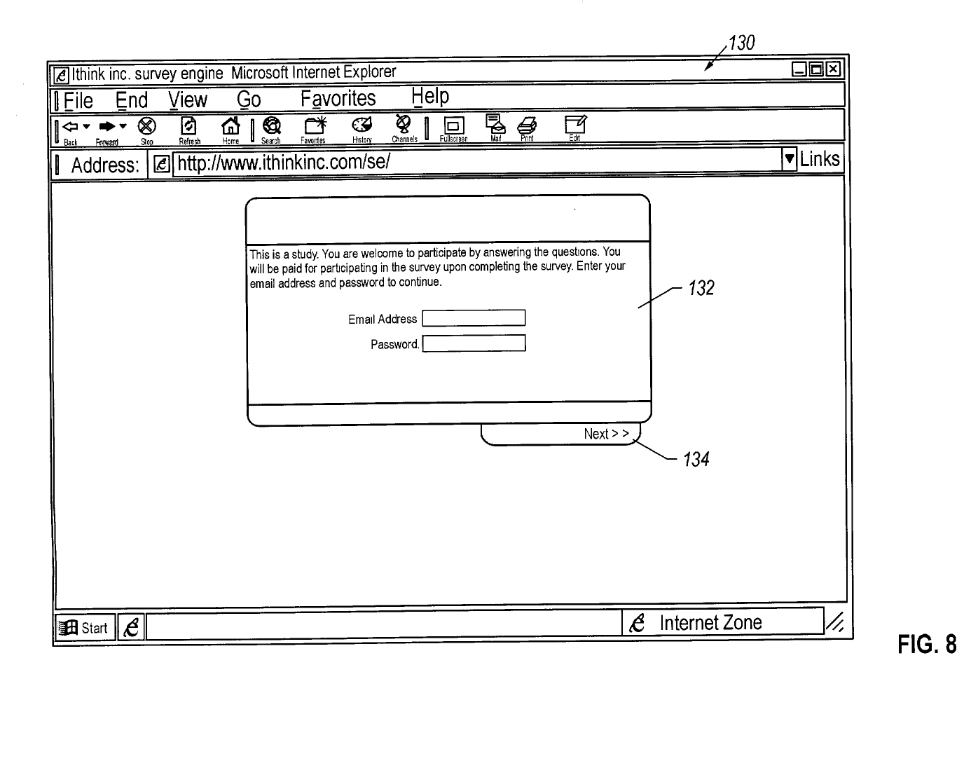

Once potential respondents have been contacted, the potential respondents login to the survey. Referring to FIG. 8, a respondent interface 130 is illustrated wherein a login menu 132 is provided for the respondent to login to the survey by entering his or her username and password and pressing a next icon 134. In the preferred embodiment, the interface is implemented by using the Internet and accessed using any one of a number of commercially-available web browsers, such as Microsoft Internet Explorer and Netscape Navigator. Once the potential respondent successfully logs in, the respondent is ready to participate in the survey. The respondent interface is particularly useful in creating a time and place for the respondent to participate in the survey at his own convenience.

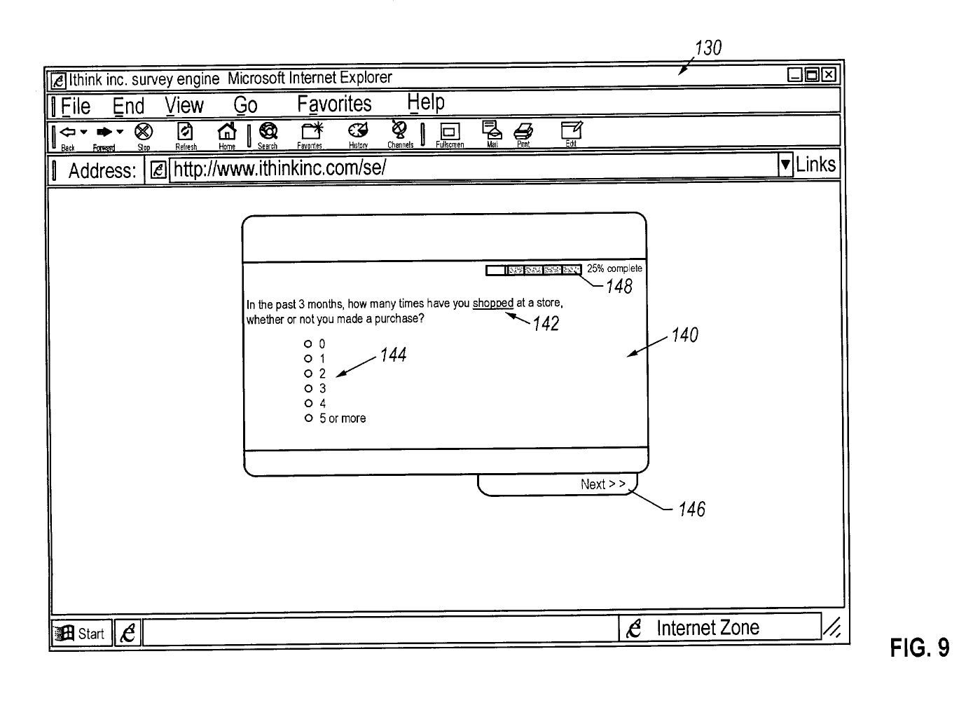

Referring to FIG. 9, respondent interface 130 is presented wherein a respondent may respond to a question 140 in the survey. Question 140 comprises instruction 142 and answer 144. An answer may comprise potential responses or a text box for the respondent to communicate a textual response. The potential answer or textual response which the respondent selects is the response. After selecting a response from answers 144, the respondent clicks the next icon 146 and the respondent interface displays the next question. As should be apparent to those skilled in the art, the presentation of questions is simple and a respondent does not need a sophisticated understanding of computers or software to participate in the survey.

The response is then communicated back to the researcher server system in substantially real-time where the response is tabulated in substantially real-time. Preferably, a progress bar 148 is included that tracks the respondent's progress through the survey. The progress bar is particularly useful in retaining respondents who begin the survey by informing the respondent of their progress.

The survey preferably includes several blind and verification questions at the beginning of the survey. For example, as illustrated in FIG. 9, the verification instruction asks “In the past 3 months, how many times have you shopped at a store, whether or not you made a purchase?” The survey is interested in the shopping habits of consumers. Therefore, any respondent that selects 0 as the response is not needed in the survey.

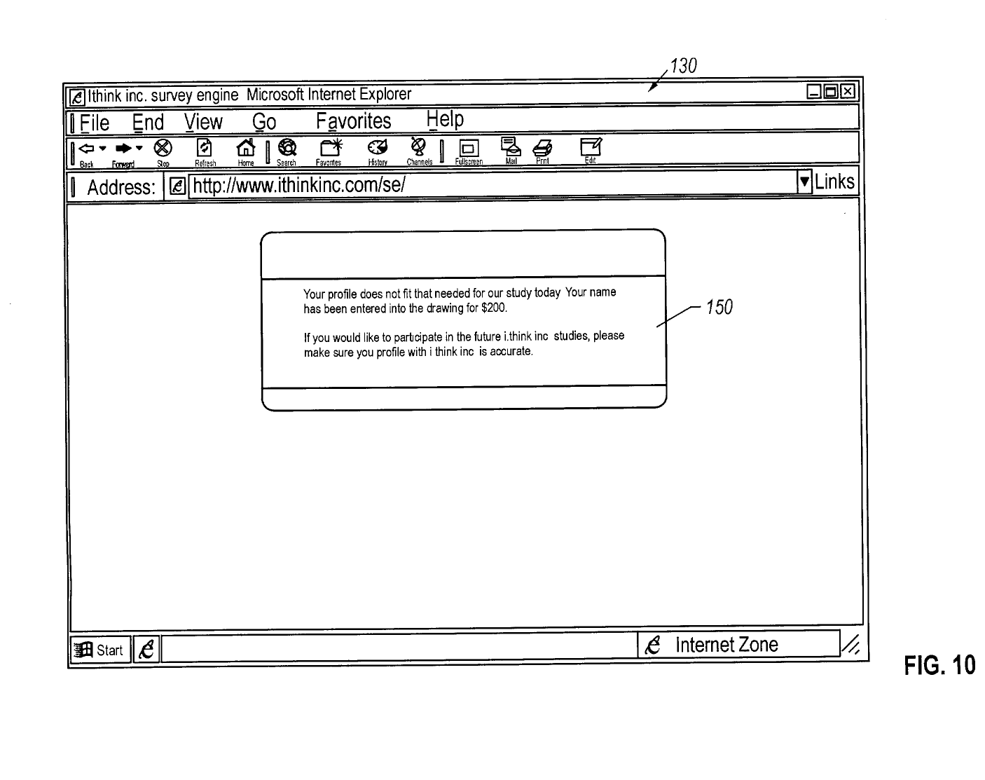

Referring now to FIG. 10, respondent interface 130 is illustrated wherein a respondent message 150 informs the respondent that his profile does not fit with the profile required for the survey and the respondent is not needed for the survey. If the respondent had selected 0 as his response to question 140 of FIG. 9, the respondent would be routed to this respondent message 150. To encourage a respondent with the incorrect profiles to continue to participate in surveys, the respondent may be awarded a parting gift such as an entry into a raffle.

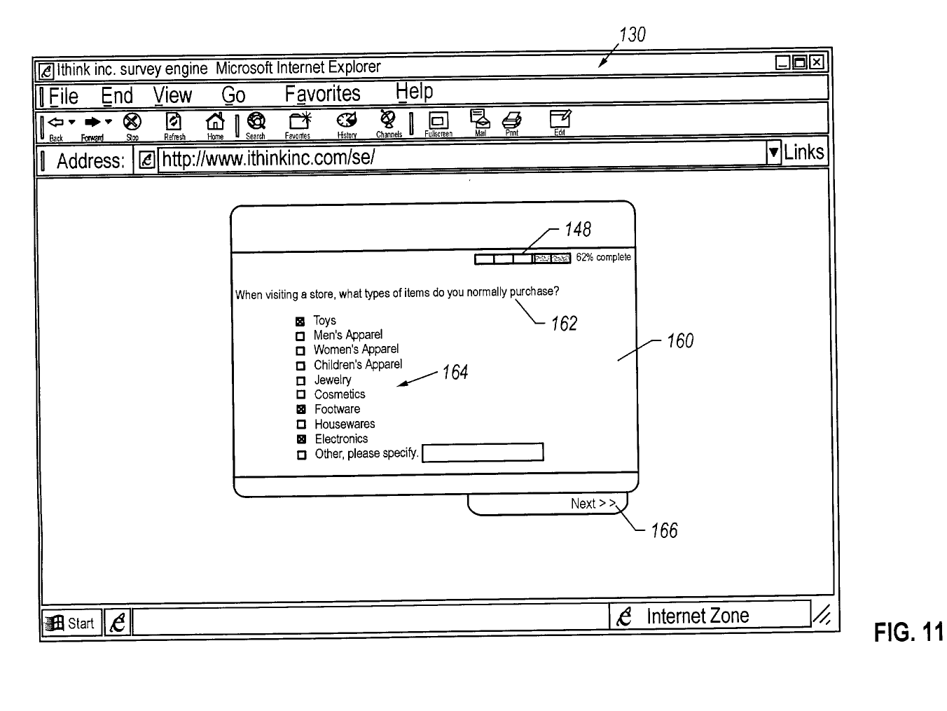

Referring now to FIG. 11, a respondent interface 130 is illustrated wherein a question 160 in the form of a multi-answer checkbox question is presented. Being presented with this question assumes that the respondent's profile is commensurate with the requirements of the survey, that is, the respondent's responses to the verification instructions match the desired respondent profile. Accordingly, based on the respondents answer to question 140 of FIG. 9, the respondent is routed to question 160. As illustrated, a multi-answer checkbox question 160 is presented having an instruction 162 and an answer 164, wherein the respondent may choose one or more responses as his response. As illustrated, the respondent selected “Toys,” “Footware” and “Electronics” as his response. After responding to question 160, the respondent clicks a next icon 166 to proceed with the survey. As previously discussed, the respondent's response is communicated to the researcher system server in substantially real-time, wherein the response is tabulated and the data compiled in substantially real-time. In addition, this data is available to the researcher or client in compiled form in substantially real-time as discussed in more detail below.

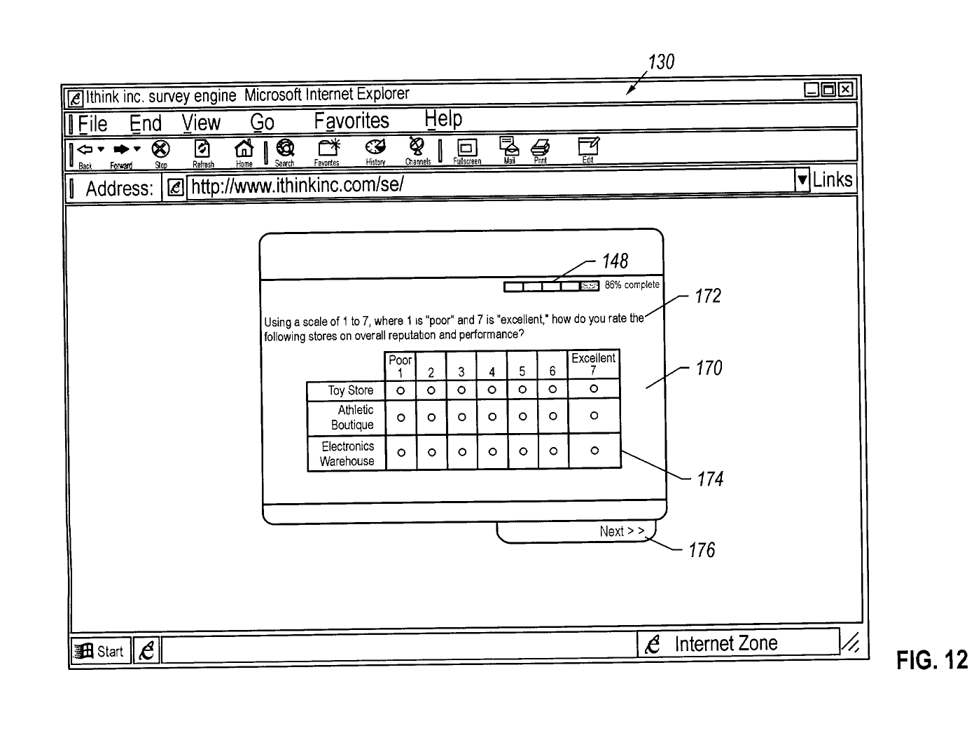

As responses to the questions are received, an answer to an unpresented question may be modified based on the responses received. For example, referring to FIG. 12, respondent interface 130 is illustrated wherein a single answer grid type question 170 is presented that comprises an instruction 172 and an answer 174. The store selections presented, Toy Store, Athletic Boutique and Electronics Warehouse, are presented based on the respondent's earlier response to question 160 of FIG. 11 which included “Toys,” “Footware” and “Electronics.” A next icon 176 allows the respondent to advance to the next question.

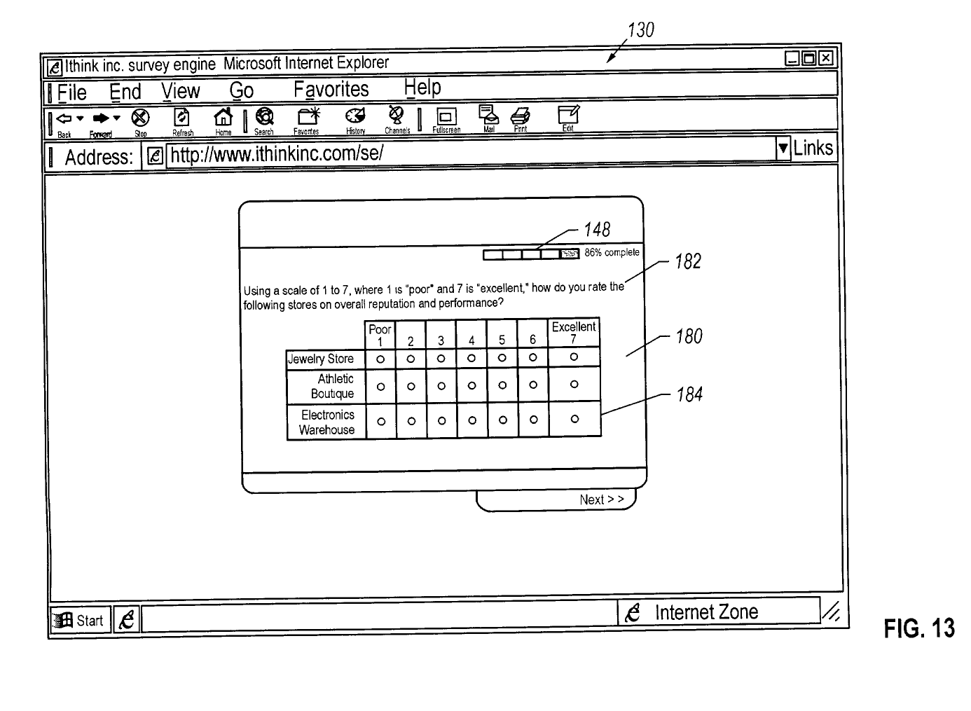

To further illustrate answer choices to an unpresented question being modified based on the responses received and referring now to FIG. 13, respondent interface 130 is illustrated wherein a single answer grid type question 180 is presented that comprises an instruction 182 and an answer 184. If the respondent had previously responded to question 160 by selecting “Jewelry,” “Footware” and “Electronics,” then, as illustrated in FIG. 13, the answer 184 in FIG. 13 includes Jewelry Store, Athletic Boutique and Electronics Warehouse.

Preferably an advanced logic system or other system well known in the art is employed to modify the answer choices of an unpresented question based on the responses received. More preferably the advanced logic is based on a neural network, an expert system, fuzzy logic or a combination thereof.

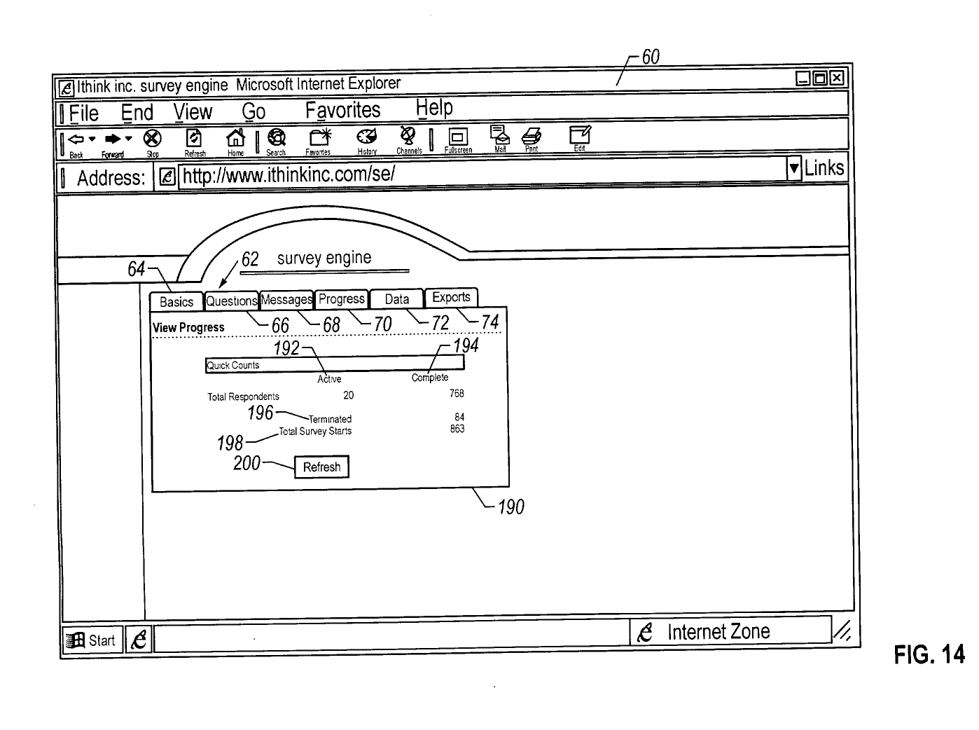

The respondent continues to respond to questions until the survey is complete. Each response is communicated to the researcher server system, wherein the response is tabulated and the data compiled. Referring now to FIG. 14, client interface 60 is illustrated wherein the client is viewing the progress of the survey on a progress menu 190 by selecting the progress tab 70. It should be understood by those skilled in the art that the client may be checking the progress of the survey while the survey is being conducted, that is before the survey is closed, or after the survey is complete.

Progress summary 190 indicates the total number of respondents that are presently taking the survey at an active indicator 192 and the total number of respondents who have completed the survey at a completion indicator 194. Progress summary 190 also indicates the number of respondents that did not meet the survey profile at termination indicator 196 and the total number of survey starts at survey start indicator 198. A refresh button 200 allows the client to refresh progress summary 190 with real-time results. Alternatively, progress summary 190 automatically refreshes after a certain incurment of time.

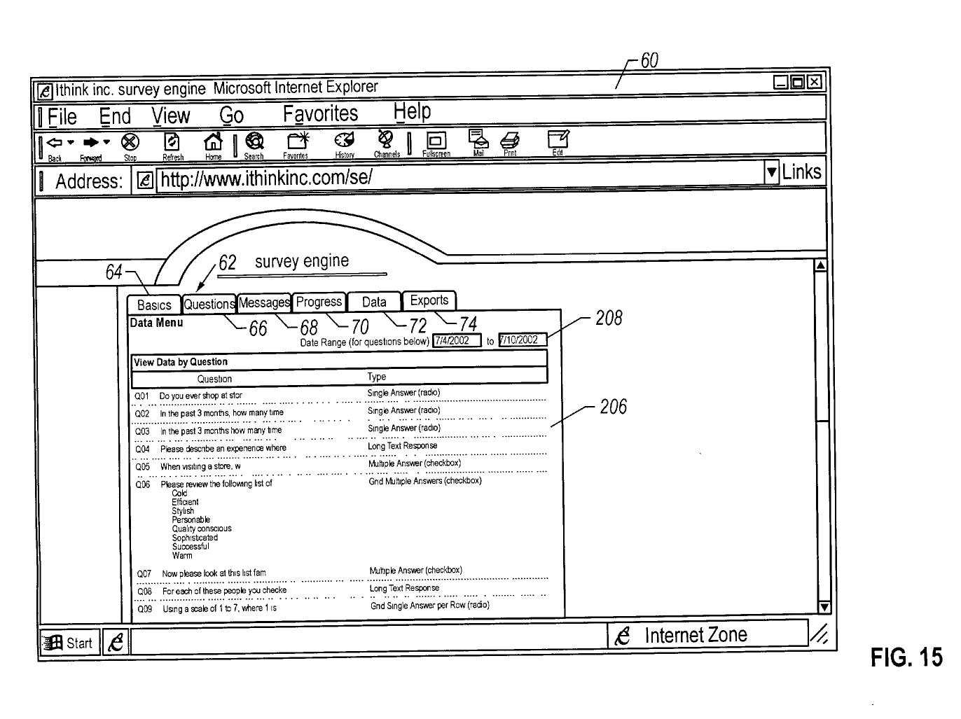

Referring now to FIG. 15, client interface 60 is illustrated wherein a data menu 206 is provided that allows the client to select a question for compilation. By clicking on data tab 72 the illustrated data menu 206 is loaded and built. To select a question to compile, the client double-clicks the desired question. Date range indicator 208 allows a question to be compiled over a specific date range. This feature of the present invention is particularly useful to a client or researcher who wants to study a particular period of time in an on-going open survey.

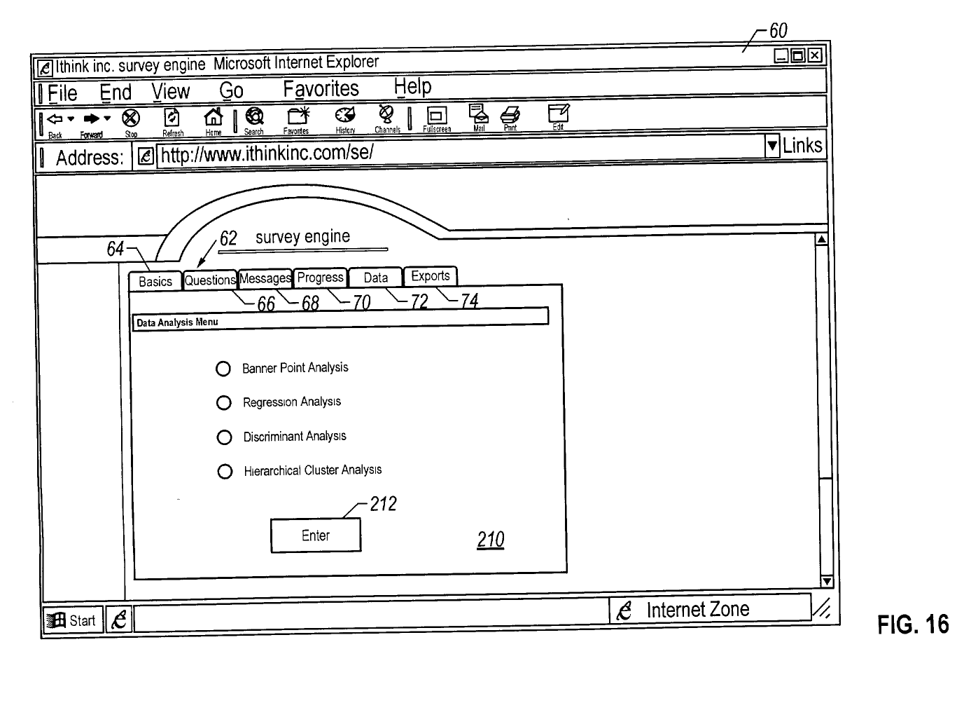

Referring now to FIG. 16, client interface 60 is illustrated wherein the client may select the type or types of data analysis to be performed on a data analysis menu 210. By double clicking on Q10 of the data menu, the illustrated menu is loaded and built. The data analysis may be as simple as banner point analysis, aggregation analysis, inferential univariate or bivariate analysis or a more complex multivariate analysis. The multivariate analysis may be regression analysis, discriminant analysis, factorial multivariate analysis of variance, factor analysis, hierarchical cluster analysis partition cluster analysis or other data analysis well known in the art. Upon selecting the type of data analysis to be performed, an enter icon 212 is clicked and the researcher server system conducts the data analysis.

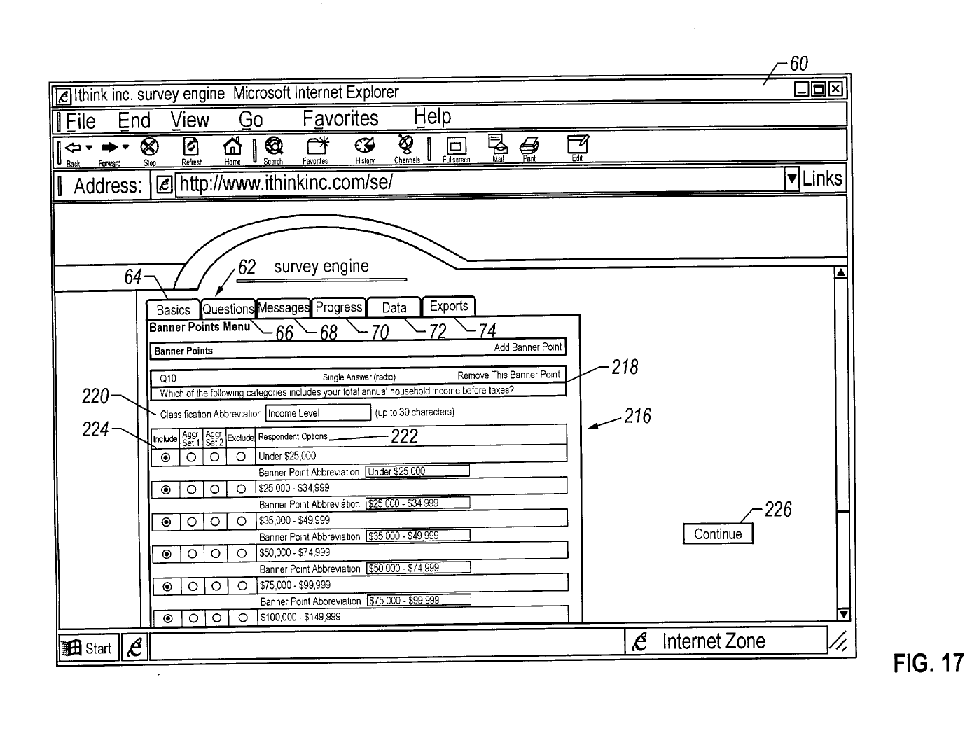

Referring now to FIG. 17, client interface 60 is illustrated wherein a banner points menu 216 is presented that allows the client to select parameters, such as an income banner points, for analyzing the selected question, in this case Q10. By checking the Banner Points Analysis box and clicking enter icon 212 of FIG. 16, the illustrated menu is loaded and built. Banner points menu 216 presents the question to be subjected to aggregation analysis at block 218. Classification abbreviation block 220 provides a space for the client to assign a title to the aggregation data analysis. Respondent options block 222 presents the responses and various parameters of the analysis to the client for selection. More specifically, as illustrated, the Respondent Options are presented and the client may choose to include or exclude each Respondent Option in the analysis by clicking the appropriate box at selection block 224. Additionally, the software allows the client to create aggregation sets. After selecting the appropriate parameters, the client clicks a continue icon 226. As illustrated, the client has selected to include all Respondent Options in an aggregation analysis. It should be understood by those skilled in the art that although a particular format for selecting analysis parameters has been presented, the selection of the data analysis and parameters may be presented in a variety of formats.

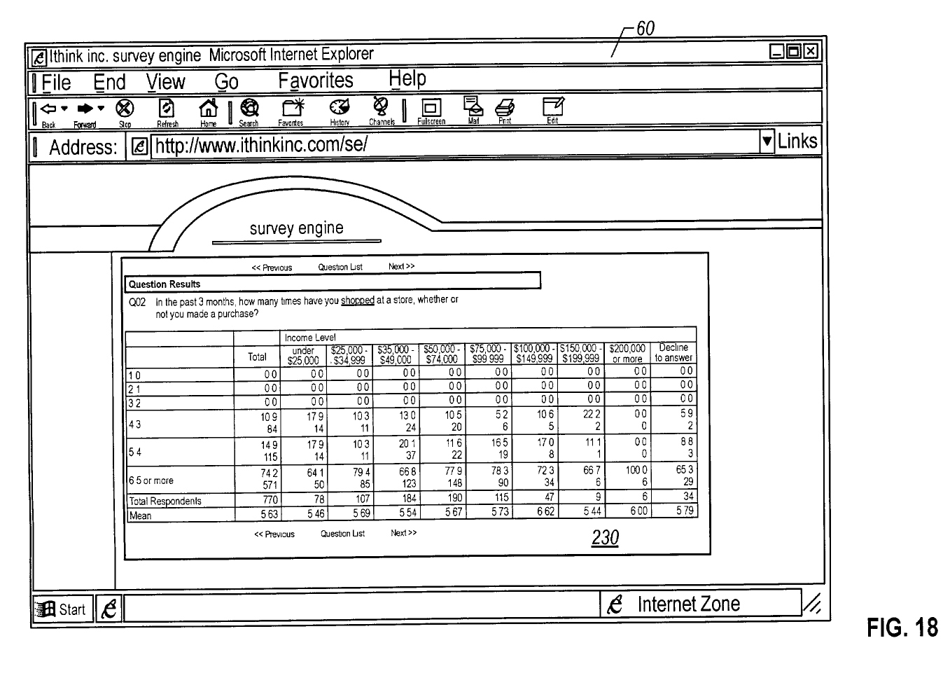

Referring now to FIG. 18, client interface 60 is illustrated wherein an aggregation table 230 summarizing compiled data in the form of aggregated data is presented. By selecting aggregation at the data analysis menu 210 of FIG. 16 and selecting the appropriate parameters in the banner points menu 220 of FIG. 17, the researcher server system performs the necessary calculations for the aggregation analysis and displays the results in substantially real-time either during or following the conducting of a survey.

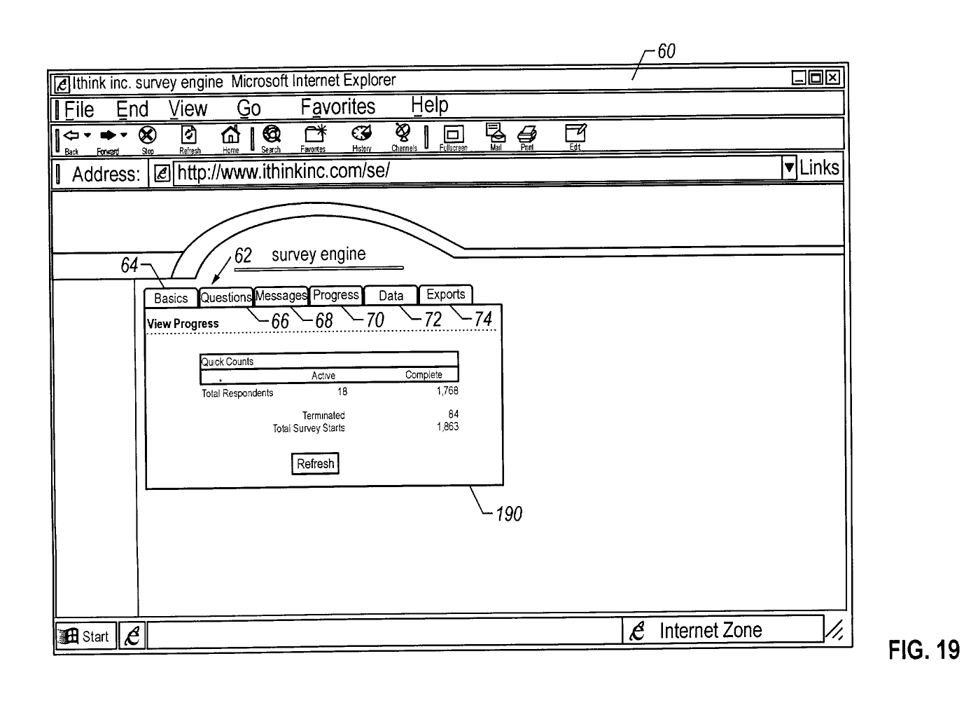

Referring now to FIG. 19, client interface 60 is illustrated wherein the client is viewing the progress of the survey on a progress menu 190 by selecting the progress tab 70. The survey has progressed since the client viewed the progress menu 190 at FIG. 14. As previously discussed, the client may choose to re-compile the results to reflect the newly tabulated data. Preferably, the re-compiling does not require the data analysis selections to be rebuilt.

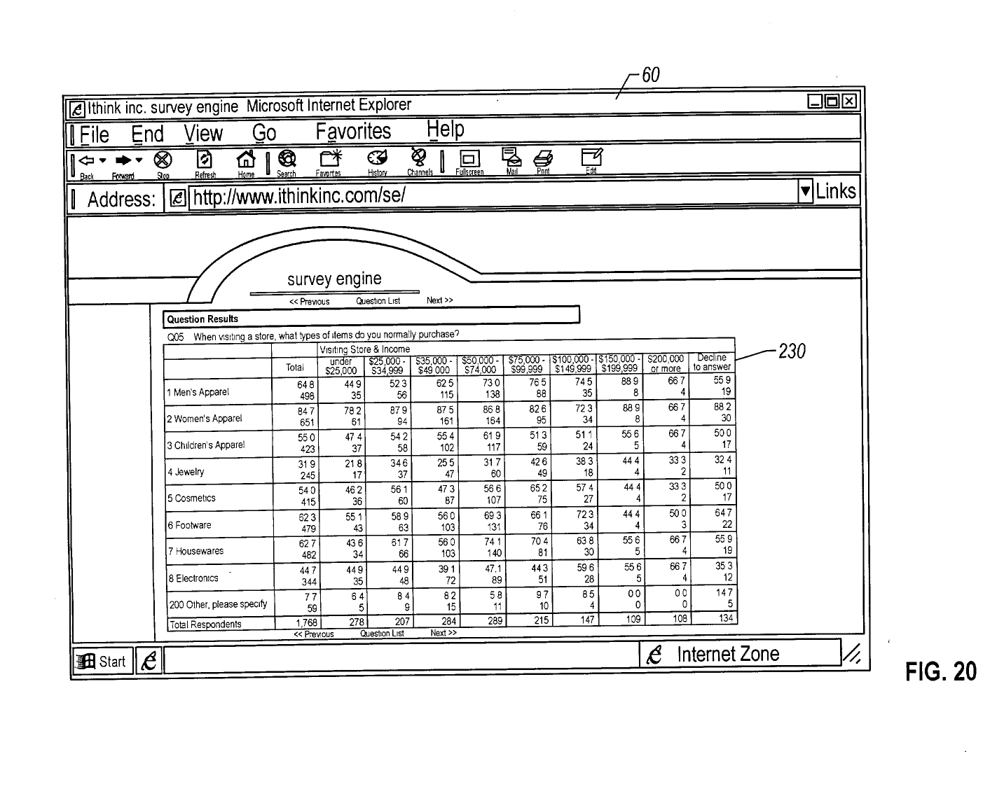

Referring now to FIG. 20, client interface 60 is illustrated wherein the client is viewing an aggregation table 230 that displays compiled data in the form of aggregated data. This aggregation table 230 is formed from the data tabulated at the latter time as illustrated in progress menu 190 of FIG. 19. The client obtained aggregation table 230 by selecting a question for compilation at the data menu as discussed with reference to FIG. 15, selecting the appropriate parameters at the data banner points menu as discussed with reference to FIG. 17 and selecting aggregation as the type of analysis to performed at the data analysis menu as discussed with reference to FIG. 16. Thus, the client or researcher is provided compiled market research data over a computer network in substantially real-time. Moreover, the client or researcher may select multiple types of data analysis to provide the information to solve marketplace issues. Thus, the cycle between data collection, analysis and decision making is shortened.

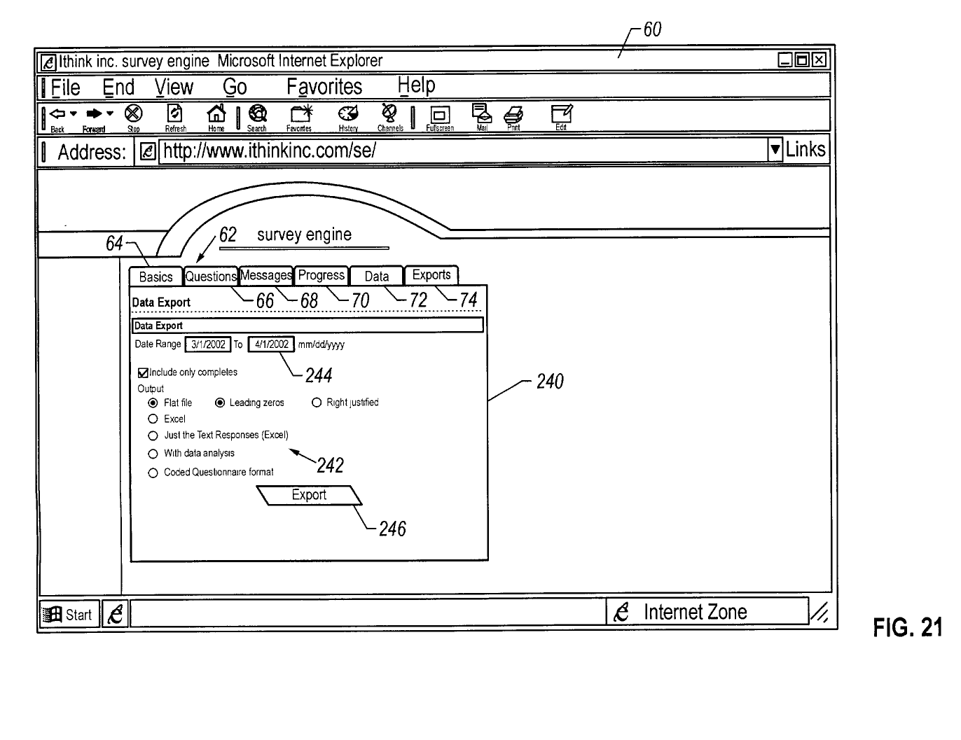

Referring now to FIG. 21, client interface 60 is illustrated wherein an export menu 240 is presented that allows the client to select the data export to be performed. The export menu is loaded and built by selecting the exports tab 74. As previously discussed, the client may select a variety of output types at output selections 242. The compiled data may be formatted in a predetermined format. For example, the data may be raw data or a Microsoft Excel file. The formatting may include a flat file with leading zeros or right justification. Moreover, the formatted data or responses may have be subjected to data analysis. Additionally, at date range entry 244 the client may select a specific date range for the compiled data. The feature is particularly useful in measuring consumer sediments over a period of time. The client clicks export button 246 to begin the process.

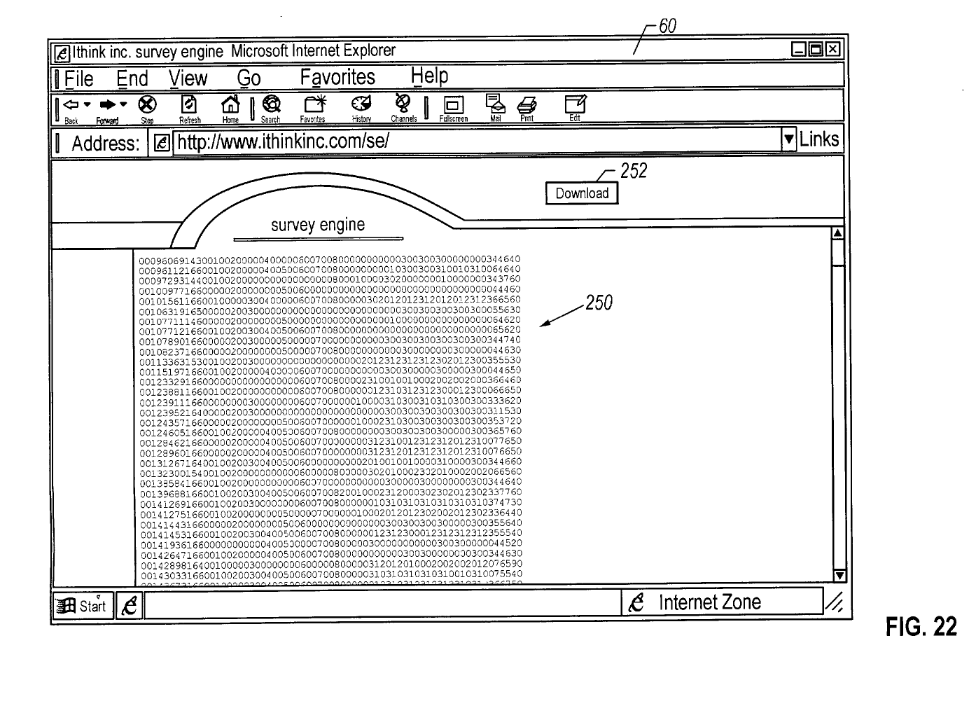

Referring now to FIG. 22, client interface 60 is illustrated wherein the compiled data is presented in a raw data format 250. By selecting flat file format at export menu of FIG. 21, the researcher server system presents the raw data to the client for viewing and or downloading. The client may download the compiled marketing research data by clicking on the download icon 252. This feature of the present invention is particularly useful to the client or researcher. For example, substantially real-time analysis may be downloaded for integration into a report or raw data may be downloaded for archives.

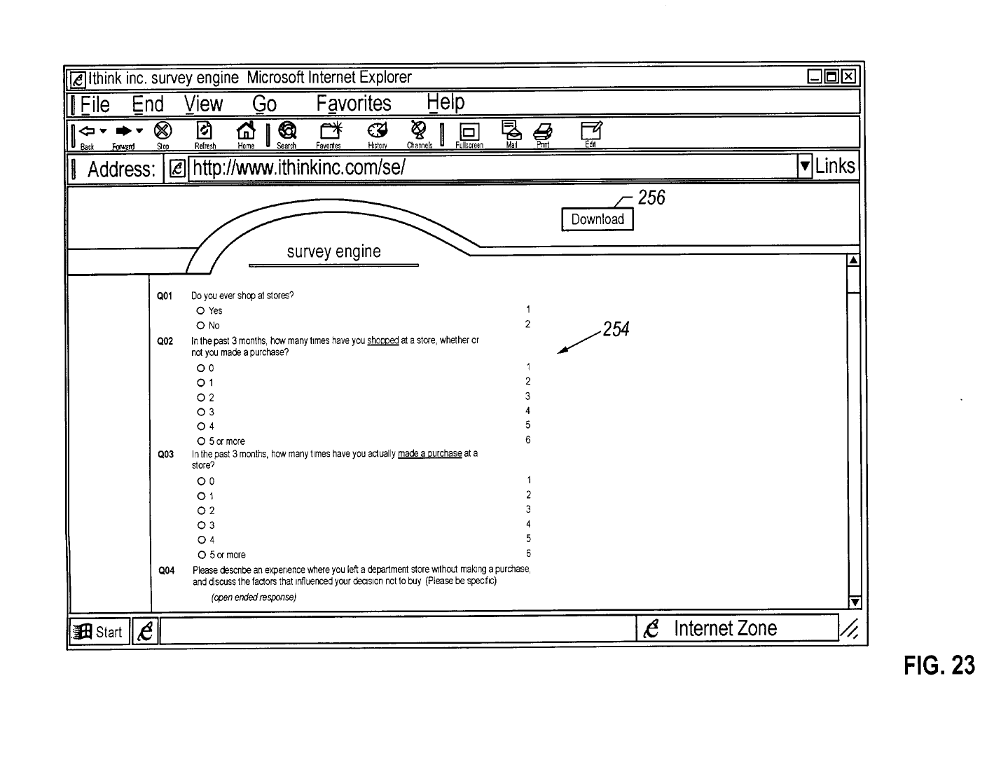

Additionally, referring now to FIG. 23, client interface 60 is illustrated wherein a coded questionnaire format 254 is presented to the client for downloading. By selecting coded questionnaire format at export menu of FIG. 21, the researcher server system presents the coded questionnaire to the client for viewing and or downloading. The client may download the coded questionnaire by clicking on the download icon 256. The coded questionnaire provides a concise and ready reference of the contents of the survey that includes the answer coding.

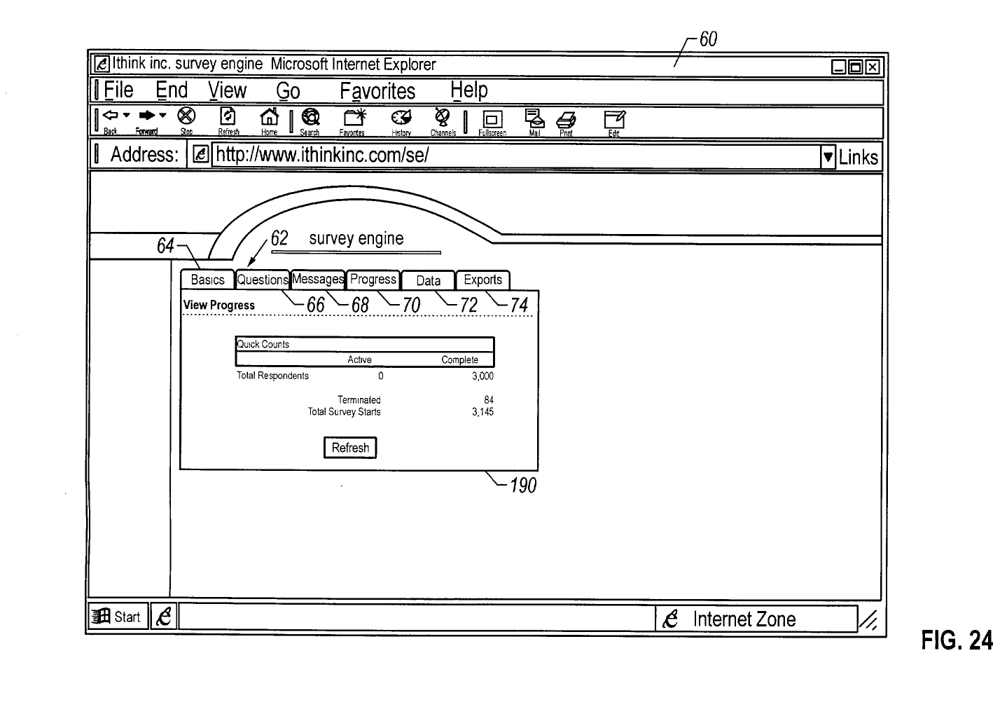

Referring now to FIG. 24, client interface 60 is illustrated wherein the client is viewing the progress of the survey on progress menu 190. The survey has progressed since the client viewed previous menu 190 at FIG. 19 and the survey is complete. At this time the survey is complete and the client may perform final compilation and exportation in the same manner as discussed above. The client or researcher may choose to run substantially real-time data analysis on the final tabulated data to provide a report. Thus, the cycle between data collection, analysis and decision making in the marketplace is shortened. Although the functionality of the present invention has been described with a specific format, i.e. tabs and a browser environment, it should be understood by those skilled in the art that the functionality of the present invention may take other forms.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A system for creating compiled marketing research data over a computer network comprising:
a researcher server system operable to provide a plurality of questions, to receive corresponding survey responses to the questions and to compile the responses in substantially real-time;
a plurality of respondent systems in communication with the researcher server system, each of the plurality of respondent systems operable to receive the questions from the researcher server system and provide the corresponding responses to the researcher server system; and
at least one client system in communication with the researcher server system, the client system operable to access the compiled responses in substantially real-time, thereby creating compiled marketing research data over the computer network.

2. The system as recited in claim 1 wherein the compiled responses comprise responses formatted into a predetermined format.

3. The system as recited in claim 2 wherein the researcher server system is operable to export the responses formatted into a predetermined format.

4. The system as recited in claim 3 wherein the compiled responses comprise responses formatted into a raw data format.

5. The system as recited in claim 3 wherein the compiled responses comprise responses subjected to data analysis.

6. The system as recited in claim 5 wherein the data analysis comprises aggregation.

7. The system as recited in claim 5 wherein the data analysis comprises a multivariate analysis chosen from the group consisting of regression analysis, discriminant analysis, factorial multivariate analysis of variance, factor analysis, hierarchical cluster analysis and partition cluster analysis.

8. The system as recited in claim 7 wherein the data analysis is operable to be chosen by the client system.

9. The system as recited in claim 1 wherein the researcher server system is operable to provide the plurality of questions during a predetermined time period.

10. The system as recited in claim 1 wherein the client system is operable to author the questions.

11. The system as recited in claim 1 wherein the researcher server system is operable to provide a coded questionnaire to the client system.

12. A method for creating compiled marketing research data over a computer network comprising the steps of:
creating a plurality of questions from a researcher server system to a plurality of respondent systems;
receiving corresponding responses to the questions from the plurality of respondent systems;
compiling the received responses at the researcher server system in substantially real-time; and
creating the compiled survey responses from the researcher server system to at least one client system in substantially real-time, thereby creating compiled marketing research data over the computer network.

13. The method as recited in claim 12 wherein the step of compiling the received responses at the researcher survey system in substantially real-time further comprises the step of formatting the responses at the researcher server system into a predetermined format.

14. The method as recited in claim 13 further comprising the step of exporting the formatted responses from the researcher server system to the client system.

15. The method as recited in claim 13 wherein the step of formatting the responses at the researcher server system into a predetermined format further comprises formatting the survey response into a raw data format.

16. The method as recited in claim 13 further comprising the step of subjecting the formatted responses to data analysis at the researcher server system.

17. The method as recited in claim 16 wherein the step of subjecting the formatted responses to data analysis at the researcher server system further comprises the step of aggregating the responses at the researcher server system.

18. The method as recited in claim 16 wherein the step of subjecting the formatted responses to data analysis at the server system further comprises the step of performing a multivariate analysis chosen from the group consisting of regression analysis, discriminant analysis, factorial multivariate analysis of variance, factor analysis, hierarchical cluster analysis and partition cluster analysis.

19. The method as recited in claim 18 further comprising the step of selecting the data analysis to be performed at the researcher server system at the client system.

20. The method as recited in claim 12 wherein the step of creating a plurality of questions from a researcher server system to a plurality of respondent systems further comprises creating a plurality of questions from the researcher server system to the plurality of respondent systems during a predetermined time period.

21. The method as recited in claim 12 further comprising the step of authoring the questions from the client system.

22. The method as recited in claim 12 further comprising the step of creating the client system a coded questionnaire.

23. A method for presenting a survey to a respondent comprising the steps of:
generating a plurality of unpresented questions, each unpresented question comprising an instruction and an answer;
sequentially presenting each of the plurality of unpresented questions to the respondent, thereby each unpresented question becomes a presented question;
sequentially receiving responses from the respondent to each of the presented questions;
modifying an answer to one of the unpresented questions of the plurality of questions based upon at least one of the received responses; and
presenting the modified unpresented question to the respondent.

24. The method as recited in claim 23 wherein the step of modifying an answer to one of the unpresented questions further comprises the step of employing an advanced logic system to modify the answer to one of the unpresented questions.

25. The method as recited in claim 24 wherein the step of employing an advanced logic system to modify the answer to one of the unpresented questions further comprises the step of selecting an advanced logic system from the group consisting of a neural network, an expert system and fuzzy logic.

26. The method as recited in claim 23 further comprising the step of modifying the sequence in which the unpresented questions are presented to the respondent based on the received responses from the respondent.

27. The method as recited in claim 23 further comprising the step of deleting an unpresented question based on the received responses from the respondent.

28. The method as recited in claim 23 further comprising the step of selecting the plurality of questions from the question types consisting of radio, checkbox, short text, long text, scaled response, multiple choice, grid with single answer and grid with multi-answer.

29. The method as recited in claim 23 further comprising the step of selecting a stimulus to accompany the presentation of a question, the stimulus chosen from the group consisting of an audio file, a graphical image and a video file.

30. A computer program embodied on a computer readable medium on a researcher server system for creating compiled marketing research data over a computer network comprising:
a code segment for creating a plurality of questions to a plurality of respondents;
a code segment for receiving corresponding responses from the plurality of respondents;
a code segment for compiling the received responses in substantially real-time; and
a code segment for creating the compiled responses to at least one client system in substantially real-time, thereby creating compiled marketing research data over the computer network.

31. The computer program as recited in claim 30 wherein the code segment for compiling the received responses in substantially real-time further comprises a code segment for formatting the responses into a predetermined format.

32. The computer program as recited in claim 31 further comprising a code segment for exporting the formatted responses to the client system.

33. The computer program as recited in claim 32 further comprising a code segment for performing data analysis on the formatted responses.

34. The computer program as recited in claim 33 wherein the code segment for performing data analysis on the formatted responses further comprises a code segment for performing a multivariate analysis chosen from the group consisting of regression analysis, discriminant analysis, factorial multivariate analysis of variance, factor analysis, hierarchical cluster analysis and partition cluster analysis.
